(19) United States
(12) Patent Application Publication
(10) Pub. No.: US 2005/0026634 A1
(43) Pub. Date: Feb. 3, 2005

(54) Internet distributed access network architecture

(76) Inventors: Ramabadran S. Raghavan, Flanders, NJ (US); Vivek Kansal, Randolph, NJ (US)

Correspondence Address: Michael G. Fletcher;Fletcher Yoder, P.O. Box 692289, Houston, TX, 77269-2289, US

(21) Appl. No.: 10/628,825

(22) Filed: Jul. 28, 2003

(51) Int. Cl. H04Q 7/20

(52) U.S. Cl. 455/465; 455/561

(57) ABSTRACT

A distributed access network architecture utilizes an undedicated public network, such as the internet, to provide connectivity between portions of the network. In one example, the public network is utilized as the communication interface between base transceiver units and an access network unit. Each of these network elements may include one or more protocol layers to facilitate communication over the public network.

### BACKGROUND OF THE INVENTION

1. Field Of The Invention

The present invention relates generally to wireless communications systems and, more particularly, to a wireless communications system that utilizes the internet.

2. Description Of The Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Over the past several decades, wireless communications systems, sometimes referred to as mobile telephone systems or cellular telephone systems, have continued to evolve. Although the first mobile telephone system for the public was introduced in 1946, and improved in 1965, modern wireless technology was introduced in 1970 as the Advanced Mobile Phone Service (AMPS), which became America's analog cellular standard. In an AMPS system, the limited number of radio frequencies available for mobile service were “stretched” by scattering multiple low-power transceivers throughout a metropolitan area and by “handing off” calls from one transceiver to another as customers moved around in the area. In other words, each transceiver defined a “cell,” and a customer's cellular telephone communicates with different transceivers as the customer moves from one cell to another.

In any given cellular market, such as a typical metropolitan area, a wireless communications system, or cellular network, typically includes at least one mobile switching center that is coupled to multiple base transceiver stations via a fixed network. The mobile switching center is the switch that serves the wireless system, and it performs the function of switching calls to the appropriate destination and maintaining the connection. Indeed, the primary purpose of the mobile switching center is to provide a voice path connection between a mobile telephone another telephone, such as another mobile telephone or a land-line telephone. A typical mobile switching center includes a number of devices that control switching functions, call processing, channel assignments, data interfaces, tracking, paging, call hand-off, billing, and user data bases.

The mobile switching center is typically coupled to the Public Switched Telephone Network (PTSN), which is often referred to as a land-line telephone network. A typical cellular network includes a connection to the PSTN because a majority of all cellular telephone calls are initiated from mobile/portable cellular telephones.

As can be appreciated, a typical mobile switching center requires a significant capital expenditure. Furthermore, a single mobile switching center may not be able to handle the cellular traffic when new cellular sites are deployed in a given wireless market. As a result, another mobile switching center may be installed, or the existing mobile switching center may be relocated and enlarged so that it may adequately service the traffic load on the network.

Although mobile switching centers represent a significant capital expenditure, there are relatively few mobile switching centers in a typical cellular network as compared with the number of base transceiver stations. As mentioned above, each base transceiver station essentially defines a cell of the cellular network, because each base transceiver station serves as the air interface between the mobile telephone and the cellular system. Cell sizes can range in size from less than a mile across, up to about 30 miles across, depending upon terrain, system capacity, and geographic location. For example, a rural cellular network may have just a few base transceiver stations, while a cellular network in a densely populated metropolitan area may require dozens, or even hundreds, of base transceiver stations.

Each base transceiver station typically includes a radio tower, antennas and cabling, equipment (such as a base band subsystem and an RF system), and a shelter or cabinet that houses the equipment. Furthermore, the space in which the base transceiver station is located must be rented, leased, or purchased. As a result, the average cost to build a typical base transceiver station usually exceeds $500,000.00—a capital expenditure which must be repeated for every base transceiver station in the network.

Because of the high cost of base transceiver stations, attempts have been made in recent years to distribute certain processing functionality of the base transceiver station. As mentioned previously, a typical base transceiver station includes a base band subsystem and an RF subsystem. The RF subsystem typically includes the antennas and transceivers (sometimes called base station radios) that communicate with mobile telephones over the air interface. The base band subsystem, on the other hand, typicaly includes a processor that handles communication between the RF subsystem and the mobile switching center. In an undistributed system, each base transceiver station includes a base band subsystem that is coupled via a hardline, usually via fiber optics, to the mobile switching center. While the RF subsystems, or transceiver units as they are sometimes called, must be placed in multiple locations to form the cells, the base band subsystems may be located separate from the RF subsystems that they serve, thus forming a distributed system. For example, several base band subsystems may be located in a central area, with each base band subsystem using a dedicated link to its respective RF subsystem, usually via a point-to-point optical fiber. Accordingly, in a distributed system, the cost of each base transceiver station may be reduced, the base band subsystems may be consolidated, and the servicing and maintenance of the base band subsystems may be simplified.

Despite the benefits of such a distributed network, a distributed network continues to rely upon dedicated connections between the various elements of the network. In addition to the high cost of providing dedicated connections, such as fiber optic cabling, between one or more base band subsystems and multiple RF subsystems, such dedicated connectivity limits network flexibility. It should be appreciated that the wireless industry has grown dramatically in the past fifteen years, yet the average subscriber's monthly bill has declined by over fifty percent. Such decrease is the result of increased competition and maturity in the wireless industry. As a result, participants in the wireless industry must find ways to reduce capital expenditures further to remain competitive.

### SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

In accordance with one aspect of the present invention, there is provided a wireless communications system. The system may include at least one transceiver unit adapted to communicate over an air interface with portable communications devices and adapted to communicate over an undedicated public network. The system also may include an access network unit adapted to communicate with the at least one transceiver unit over the public network.

In accordance with another aspect of the present invention, there is provided an access network unit for use with a wireless communications system. The access network unit may include a communication interface to facilitate communication between the access network unit and at least one transceiver unit over an undedicated public network.

In accordance with still another aspect of the present invention, there is provided a method of communicating in a wireless communications system. The method may include the act of communicating information over an undedicated public network between at least one transceiver unit, which is adapted to communicate over an air interface with portable communications devices, and an access network unit, which is adapted to process information communicated with the at least one transceiver unit.

### BRIEF DESCRIPTION OF THE DRAWINGS

Advantages of the invention may become apparent upon reading the following detailed description and upon reference to the drawings in which:

FIG. 1 discloses an exemplary embodiment of an internet distributed access network architecture in accordance with the present invention;

FIG. 2 discloses an exemplary embodiment of a network incorporating the internet distributed access network architecture of FIG. 1; and

FIG. 3 illustrates an exemplary protocol overview of the internet distributed access network architecture of FIG. 1.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The techniques disclosed herein provide a paradigm shift in the way distributed architectures for wireless networks may be designed. Specifically, the techniques described herein utilize the benefits and advantages of an undedicated public network, such as the internet, to replace dedicated connections between elements of a distributed network. The connectivity between various network elements can be realized using an open (standardized) interface or using a proprietary interface, using various network configurations (such as star, ring, and daisy-chain configurations, for example), and supporting one or more technologies (such as GSM, TDMA, CDMA, and other technologies). As a result, these techniques not only provide a flexible network solution, but also may offer a significant reduction in capital expenditures.

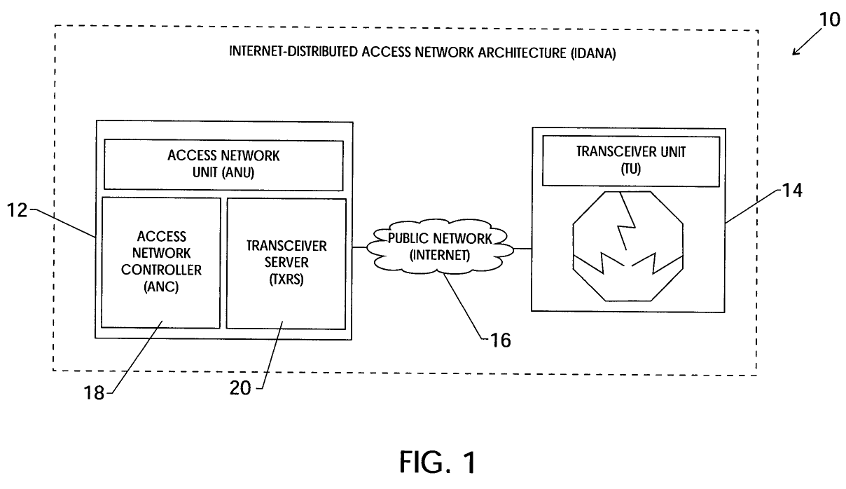

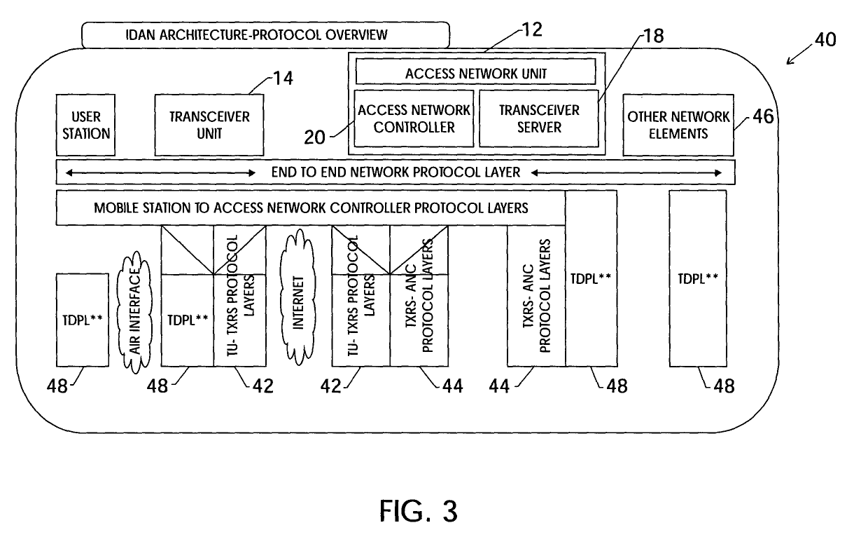

Turning now to the drawings, and referring initially to FIG. 1, an example of an internet distributed access network architecture (iDANA) is illustrated and generally referred to by a reference numeral 10. In this example, the iDANA 10 includes two units: an access network unit 12 and a transceiver unit 14. The access network unit 12 is coupled to the transceiver unit 14 via an undedicated public network 16, such as the internet. In this embodiment, the access network unit 12 includes an access network controller 18 and a transceiver server 20. The access network controller 18 provides the call processing and control functions of the access network unit 12, and the transceiver server provides the server functionality to identify the correct transceiver unit 14 and to provide connectivity to the various distributed transceiver units 14 via the public network 16. Indeed, both the transceiver server 20 and the transceiver unit 14 possess the capability to meet the connectivity requirements to route information, i.e., voice and/or data, via the public network 16. Examples of protocol used for such connectivity are described below in reference to FIG. 3.

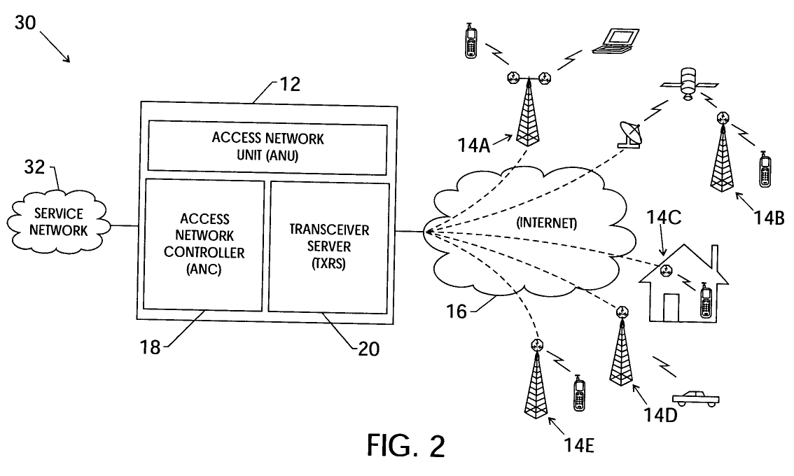

Before discussing this protocol, however, it is useful to discuss an example of the iDANA 10 in an exemplary wireless communications network. Such an exemplary network is illustrated in FIG. 2 and generally referred to by the reference numeral 30. As can be seen, each access network unit 12 may be connected to various transceiver units 14A, 14B, 14C, 14D, and 14E via a public network 16, such as the internet. It should be understood that the transceiver units 14A-E may take any suitable form. For example, the transceiver units may include antennas mounted on a tower, such as shown by the transceiver units 14A, 14B, 14D, and 14E, or the transceiver units may include an antenna mounted on a building, such as the transceiver unit 14C. Furthermore, the transceiver units 14A-E may communicate voice and/or data with any suitable communications device, such as portable cellular telephones, vehicles having mobile cellular telephones and/or navigation systems, computer systems having wireless modems, and/or satellite systems. Furthermore, the transceiver units 14A-E may be different sizes to provide different coverage footprints, such as macro, micro, pico, and nano.

Whereas a single access network unit 12 may support multiple technologies, e.g., TDMA, CDMA, and GSM, a separate transceiver unit 14A-E may be dedicated for each technology supported by the access network unit 12. In this example, the access network controller 18 contained within the access network unit 12 may provide a common platform to support these multiple technologies. The transceiver server 20 in the access network unit 12 may route the different technologies to the correct transceiver unit 14A-E using the public network 16 as the distribution media.

With a network architecture based on these techniques, there are several network deployment options available for an operator. For example, the access network unit 12 may be located at a common site or location, and the transceiver units 14A-E may be distributed across the coverage area specific to that particular operator. Because the transceiver units 14A-E may be located in any area in which access to the public network 16 is possible, the installation locations are virtually endless. Furthermore, with no capital expenditures for purchasing and running dedicated lines, such as fiber optic cables, to each transceiver unit 14A-E, a significant cost savings may be realized. In addition, because running such dedicated lines is both labor and time intensive, new cell sites may be installed in much less time, e.g., a few weeks as opposed to several months. Of course, because the access network units 12 may be located with other network elements, significant cost savings may be realized in this regard also.

Because the access network unit 12 communicates with the transceiver unit 14 via the undedicated public network 16 instead of via dedicated lines, the communication protocol between the access network unit 12 and the transceiver unit 14 is different than a situation in which dedicated lines are used. Specifically in this example, the transceiver server 20 and the transceiver unit 14 may include at least one protocol layer to enable them to communicate with one another via the public network 16, and the transceiver server 20 and the access network controller 18 may include at least one protocol layer to enable them to communicate information from or destined for the public network 16. An overview of these protocol layers, and others, is illustrated in FIG. 3.

The protocol layers between the transceiver unit 14 and the transceiver server 20 are designated as the Tu-TxrS protocol layers 42. These protocol layers 42 define the connectivity between the transceiver unit 14 and the transceiver server 20. For both the transceiver unit 14 and the transceiver server 20, the lower layers of this protocol may meet the requirements for providing connectivity to an appropriate internet connection. For the transceiver unit 14, the protocol layers above the physical layer may be designed so that the transceiver unit 14 is able to: (1) assign and/or maintain the IP address provided by the transceiver server 20; (2) convert the base band information received from the access network controller 18 via the transceiver server 20 to the appropriate RF signals pertaining to a specific interface employed, and this function may include modulation, up conversion, transmit amplification and filtering, for example; (3) convert the RF information to base band to the access network controller 18 via the transceiver server 20, and this function may include demodulation, down conversion, receive amplification and filtering, for example; (4) define and/or provide security information to provide a secure connection to the transceiver server 20 via the public network 16; (5) negotiate quality of service for the connection to the transceiver server 20; and/or (6) encapsulate the higher layer protocol information to the appropriate internet protocol layer requirements. Similarly, for the transceiver server 20, the protocol layers above the physical layer may be designed such that the transceiver server 20 is able to: (1) assign and/or maintain the IP addresses of the various transceiver units 14 supported by that particular transceiver server 20; (2) map the IP addresses of the various transceiver units 14 to the technology supported by a particular transceiver unit 14 such that the technology dependent information from the access network controller 18 can be transmitted to the correct transceiver unit 14; (3) define and/or provide security information to provide a secure connection to the transceiver units 14 via the public network 16; (4) negotiate the quality of service for the connection to the transceiver units 14; and (5) encapsulate higher layer protocol information to the appropriate internet protocol layer requirements.

The TxrS-ANC protocol layers 44 define the connectivity between the transceiver server 20 and the access network controller 18. Because both the transceiver server 20 and the access network controller 18 are functionally implemented in a single access network unit 12, in this example, an appropriate physical layer may be defined based on the technology platform on which these functions are realized. Indeed, it should be recognized that although the access network controller 18 provides the call processing and control functionalities for a particular access technology between the access network controller 18 and the transceiver server 20, the access network controller 18 also provides the protocol for connectivity between the access network controller 18 and other network elements 46 based on technology dependent protocol layers (TDPL) 48. Depending upon the access technology, e.g., GSM, TDMA, and CDMA, details of the TDPL 48 can be found in the relevant access technology standards. Furthermore, the protocol layers defined in the iDANA 10 may follow the OSI reference model and may include network layers, routing protocols, transport layer, session layer, and presentation layer(s).

It should be understood from the techniques discussed above that the number of access network units 12 in a network 30 may be relatively few compared to the number of transceiver units 14. Indeed, given an access network unit 12 of sufficient capacity, a single access network unit 12 could theoretically be used to support a nationwide, or even a worldwide, network 30. In one example, a single access network unit 12 could be located in the United States and have sufficient capacity in its access network controller 18 and its transceiver server 20 to provide connectivity and information via the public network 16 to all transceiver units 14 located in the United States or, indeed, located worldwide. In this example, information packets, e.g., voice and/or data packets, can be transmitted from the access network unit 12 to the correct transceiver units 14 and vice versa via the public network 16. Of course, depending upon a variety of factors, multiple access network units 12 may be utilized in a given network 30. These multiple access network units 12 may be located at a common site, or they may be located separately, e.g., regionally, so that each access network unit 12 services a subset of the transceiver units 14 in he network 30.

It should further be understood that the techniques described herein may be implemented through software, hardware, or any suitable combination thereof. Indeed, current wireless networks may be updated through software revisions, and possibly minimal hardware revisions, to convert them from distributed systems using dedicated connections to distributed systems using internet connections as described herein. Furthermore, it is contemplated that the access network unit 12 and/or the transceiver unit 14 may use general purpose devices, such as general purpose servers, modems, routers, etc., with the appropriate software programming to carry out these techniques, or the access network unit 12 and/or the transceiver unit 14 may use special purpose processors and/or software to carry out these techniques. Furthermore, the protocols discussed above may be standard protocols or proprietary protocols depending upon various factors.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A wireless communications system comprising:
at least one transceiver unit adapted to communicate over an air interface with portable communications devices and adapted to communicate over an undedicated public network; and
an access network unit adapted to communicate with the at least one transceiver unit over the public network.

2. The system, as set forth in claim 1, wherein the public network comprises the internet.

3. The system, as set forth in claim 1, wherein the at least one transceiver unit comprises at least one antenna to facilitate communications over the air interface.

4. The system, as set forth in claim 3, wherein the at least one transceiver unit comprises a structure on which the antenna resides.

5. The system, as set forth in claim 4, wherein the structure comprises a tower.

6. The system, as set forth in claim 4, wherein the structure comprises a building.

7. The system, as set forth in claim 1, comprising at least one portable communications device.

8. The system, as set forth in claim 7, wherein the at least one portable communications device comprises a cellular telephone.

9. The system, as set forth in claim 7, wherein the at least one portable communications device comprises a vehicle having at least one of a mobile telephone and a navigation system.

10. The system, as set forth in claim 7, wherein the at least one portable communications device comprises a computer having a wireless modem.

11. The system, as set forth in claim 1, comprising a satellite system adapted to facilitate communications between the at least one transceiver unit and the access network unit.

12. The system, as set forth in claim 1, comprising a services network communicatively coupled to the access network unit.

13. The system, as set forth in claim 12, wherein the services network comprises a mobile switching center.

14. The system, as set forth in claim 12, wherein the services network comprises a publicly switched telephone network.

15. An access network unit for use with a wireless communications system, the access network unit comprising:
a communication interface to facilitate communication between the access network unit and at least one transceiver unit over an undedicated public network.

16. The access network unit, as set forth in claim 15, wherein the communication interface comprises at least one protocol layer.

17. The access network unit, as set forth in claim 16, wherein the at least one protocol layer maintains an IP address of the at least one transceiver unit.

18. The access network unit, as set forth in claim 16, wherein the at least one protocol layer maps an IP address of the at least one transceiver unit to a communications technology supported by the at least one transceiver unit to facilitate transfer of information dependent upon such communications technology to the at least one transceiver unit.

19. The access network unit, as set forth in claim 16, wherein the at least one protocol layer provides security information to the at least one transceiver unit to facilitate secure communication over the public network.

20. The access network unit, as set forth in claim 16, wherein the at least one protocol layer negotiates quality of service for communications with the at least one transceiver unit over the public network.

21. The access network unit, as set forth in claim 16, wherein the at least one protocol layer encapsulates higher layer protocol information to facilitate protocol requirements of the public network.

22. The access network unit, as set forth in claim 15, wherein the public network comprises the internet.

23. The access network unit, as set forth in claim 15, wherein the access network unit comprises:
a transceiver server adapted to communicate with the at least one transceiver unit over the public network; and
an access network controller adapted to communicate with the transceiver server and with a services network.

24. The access network unit, as set forth in claim 23, comprising at least one protocol layer between the transceiver server and the access network controller.

25. The access network unit, as set forth in claim 24, wherein the at least one protocol layer provides connectivity for network elements based on communications technology.

26. The access network unit, as set forth in claim 24, wherein the at least one protocol layer facilitates communication between the transceiver server and the access network controller.

27. The access network unit, as set forth in claim 23, wherein the access network controller provides information processing and control functions for the access network unit.

28. A method of communicating in a wireless communications system, the method comprising the act of:
communicating information over an undedicated public network between at least one transceiver unit, which is adapted to communicate over an air interface with portable communications devices, and an access network unit, which is adapted to process information communicated with the at least one transceiver unit.

29. The method, as set forth in claim 28, wherein the act of communicating information of an undedicated public network comprises the act of communication information over the internet.

30. The method, as set forth in claim 28, wherein the act of communicating information of an undedicated public network comprises the act of using at least one protocol layer adapted to facilitate communication over the public network.
